(19) United States
(12) Patent Application Publication
(10) Pub. No.: US 2020/0285937 A1
(43) Pub. Date: Sep. 10, 2020

(54) CONSUMPTION CAPACITY PREDICTION

(71) Applicant: Beijing Sankuai Online Technology Co., Ltd, Beijing (CN)

(72) Inventors: Jun XU, Beijing (CN); Shangqiang LI, Beijing (CN); Yitao ZHAI, Beijing (CN); Ziwei WANG, Beijing (CN)

(21) Appl. No.: 16/755,880

(22) PCT Filed: Sep. 28, 2018
(86) PCT No.: PCT/CN2018/108340

§ 371 Date: Apr. 13, 2020

(30) Foreign Application Priority Data
Oct. 11, 2017 (CN) 201710943388.2

(51) Int. Cl. G06N 3/04; G06Q 30/02; G06N 3/08

(52) U.S. Cl. CPC G06N 3/0427; G06Q 30/0224; G06Q 30/0269; G06N 3/08; G06N 3/049; G06N 3/0472; G06N 3/0445; G06Q 30/0201

(57) ABSTRACT

Embodiments of the present disclosure provide a consumption capacity prediction method and apparatus, an electronic device and a readable storage medium, and relates to the technical field of computers. According to one example of the method, by obtaining one or more statistical characteristic data and one or more temporal sequence characteristic data with respect to a target object from historical data of a target user, a consumption capacity of the target user with respect to the target object can be determined by utilizing a preset hybrid neural network prediction model on the basis of the one or more statistical characteristic data and the one or more temporal sequence characteristic data.

### CROSS-REFERENCES TO RELATED APPLICATIONS

This patent application claims priority to Chinese patent application No. 2017109433882 filed on Oct. 11, 2017 and entitled “CONSUMPTION CAPACITY PREDICTION METHOD AND APPARATUS, ELECTRONIC DEVICE AND READABLE STORAGE MEDIUM”, which is incorporated herein by reference in its entirety.

### TECHNICAL FIELD

The present disclosure relates to the technical field of computers, and more particularly, to a consumption capacity prediction method and apparatus, an electronic device and a readable storage medium.

### BACKGROUND

A business model of sales promotion using coupons has become popular, users can obtain price discounts of commodities and/or additional services when purchasing commodities by using the coupons, and in order to issue the coupons directed to user groups with designated consumption capacities, the consumption capacities of the users need to be determined according to consumption history of the users.

At present, three following ways are usually utilized to determine the consumption capacities of the users. The first way is to determine the consumption capacities of the users according to prices of commodities purchased by the users last time. The second way is to determine the consumption capacities of the users by randomly selecting prices of commodities purchased by the users at one time. The third way is to determine the consumption capacities of the users according to an average value of prices of historically purchased commodities of the users.

But as for the first way and the second way, the consumption capacities of the users at last time and at one time are associated with specific consumption scenes thereof, and users who purchase commodities with relatively high prices for some reasons may be determined as users with high consumption capacities. As for the third way, the prices of commodities purchased by the users in recent years may be increasing or decreasing year by year, and the average value can only reflect an overall result. Accordingly, the accuracy is relatively low when the consumption capacities of the users are determined by utilizing the prices of the commodities purchased by the users last time, the prices of the commodities purchased at one time randomly, or the average value of the prices of the historically purchased commodities.

### SUMMARY

In view of the above problems, the present disclosure is provided to provide a consumption capacity prediction method and apparatus, an electronic device and a readable storage medium that solve the above problems or at least partially solve the above problems.

According to one aspect of the present disclosure, a consumption capacity prediction method is provided, including:

obtaining one or more statistical characteristic data and one or more temporal sequence characteristic data with respect to a target object from historical data of a target user; and

determining a consumption capacity of the target user with respect to the target object by utilizing a preset hybrid neural network prediction model on the basis of the one or more statistical characteristic data and the one or more temporal sequence characteristic data.

According to another aspect of the present disclosure, a consumption capacity prediction apparatus is provided, including:

a first data obtaining module, configured to obtain one or more statistical characteristic data and one or more temporal sequence characteristic data with respect to a target object from historical data of a target user; and

a consumption capacity determining module, configured to determine a consumption capacity of the target user with respect to the target object by utilizing a preset hybrid neural network prediction model on the basis of the one or more statistical characteristic data and the one or more temporal sequence characteristic data.

According to yet another aspect of the present disclosure, an electronic device is provided, including a memory, a processor and a computer program stored on the memory and capable of running on the processor. The consumption capacity prediction method disclosed by embodiments of the present disclosure is implemented when the processor executes the computer program.

According to yet another aspect of the present disclosure, a readable storage medium is provided. A computer program is stored on the readable storage medium. The steps of the consumption capacity prediction method disclosed by the embodiments of the present disclosure are implemented when the computer program is executed by a processor.

According to the consumption capacity prediction method disclosed by the embodiments of the present disclosure, the one or more statistical characteristic data and the one or more temporal sequence characteristic data with respect to the target object are obtained from the historical data of the target user, and the consumption capacity of the target user with respect to the target object is determined by utilizing the preset hybrid neural network prediction model on the basis of the one or more statistical characteristic data and the one or more temporal sequence characteristic data. The problem that the accuracy is relatively low when the consumption capacities of the users are determined by utilizing prices of commodities purchased by the users last time, prices of commodities purchased at one time randomly, or an average value of prices of historically purchased commodities in the prior art is solved. On the basis of the statistical characteristic data and in combination with the temporal sequence characteristic data, characteristic extraction on the historical data in a temporal dimension can be implemented, so that the consumption capacity predicted by utilizing the hybrid neural network prediction model is more accurate.

The foregoing descriptions are merely an overview of the technical solutions of the present disclosure. To more clearly understand the technical features of the present disclosure, the technical means may be implemented in accordance with the content of the specification. In addition, to make the foregoing and other objectives, features, and advantages of the present disclosure more obvious and easier, detailed implementations of the present disclosure are provided below.

### BRIEF DESCRIPTION OF THE DRAWINGS

Various other advantages and benefits are clear to a person of ordinary skill in the art by reading detailed descriptions of preferred implementations below. The accompanying drawings are merely intended to show the preferred implementations and do not constitute a limitation on the present disclosure. In the whole accompanying drawings, the same reference numeral is used for indicating the same component.

FIG. 1 illustrates a flow diagram of a consumption capacity prediction method according to Embodiment I of the present disclosure;

FIG. 2 illustrates a flow diagram of a consumption capacity prediction method according to Embodiment II of the present disclosure;

FIG. 3 illustrates a schematic diagram of a hybrid neural network prediction model of the present disclosure;

FIG. 4 illustrates a specific flow diagram of step 202 according to Embodiment II of the present disclosure;

FIG. 5 illustrates a schematic flow diagram of consumption capacity prediction of the present disclosure;

FIG. 6 illustrates a structure block diagram of a consumption capacity prediction apparatus according to Embodiment III of the present disclosure;

FIG. 7 illustrates a structure block diagram of a consumption capacity prediction apparatus according to Embodiment IV of the present disclosure; and

FIG. 8 illustrates a hardware structure diagram of a consumption capacity prediction apparatus of the present disclosure.

### DETAILED DESCRIPTION OF THE INVENTION

The following describes in detail exemplary embodiments in accordance with the present disclosure with reference to the accompanying drawings. Although the accompanying drawings show the exemplary embodiments in accordance with the present disclosure, it will be appreciated that the present disclosure may be implemented in various manners and is not limited by the embodiments described herein. Rather, these embodiments are provided, so that the present disclosure is more thoroughly understood and the scope of the present disclosure is completely conveyed to a person skilled in the art.

### Embodiment I

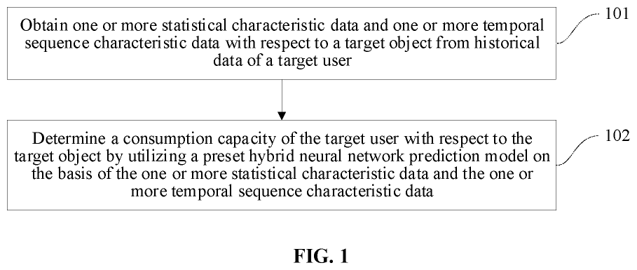

Referring to FIG. 1, a flow diagram of a consumption capacity prediction method according to Embodiment I of the present disclosure is illustrated. The method may include the following steps.

Step 101, one or more statistical characteristic data and one or more temporal sequence characteristic data with respect to a target object are obtained from historical data of a target user.

With respect to the target user whose consumption capacity to be predicted, the one or more statistical characteristic data and the one or more temporal sequence characteristic data with respect to the target object are obtained from the historical data of the target user firstly.

The statistical characteristic data include one or any combination of following data: a historical consumption price parameter of the target object within any time period, a historically browsed price parameter of the target object within any time period, a historical consumption price parameter of a non-target object within any time period, a historically browsed price parameter of the non-target object within any time period, a user level, a user active state and a permanent address of a user.

The target object may be a hotel, a KTV, a cinema ticket, a restaurant, etc., and the embodiment of the present disclosure may select the target object according to actual needs. The any time period may be selected to be a week, a month, three months, half a year, a year, etc., which is not limited by the embodiment of the present disclosure. The parameters may be selected to be an average value, a maximum value, a minimum value, a variance, a median, etc. The historical consumption price parameter includes an average value, a maximum value, a minimum value, a variance and a median of historical consumption prices. The historically browsed price parameter includes an average value, a maximum value, a minimum value, a variance and a median of historically browsed prices. The parameters are not limited by the embodiment of the present disclosure.

When the target object is a hotel, the non-target object is a set of other objects except the hotel, such as a set of the KTV, the cinema ticket, the restaurant and other objects. When the target object is the KTV, the non-target object is a set of other objects except the KTV, such as a set of the hotel, the cinema ticket, the restaurant and other objects.

The temporal sequence characteristic data include one or more of following sequences: a historical consumption price parameter sequence of the target object within a set time period, a historically browsed price parameter sequence of the target object within the set time period, a historical consumption price parameter sequence of the non-target object within the set time period, and a historically browsed price parameter sequence of the non-target object within the set time period. Parameters may be selected to be an average value, a maximum value, a minimum value, a variance, a median, etc. The parameters are not limited by the embodiment of the present disclosure.

For example, when the target object is the hotel, as for historical consumption prices of the hotel, data in last two years may be selected and divided by month. A historical consumption price average value sequence of the hotel within the set time period is a sequence constituted by 24 groups of data arranged according to a time sequence. Each group of data is a historical consumption price average value of the hotel in a current month, the first group of data is a historical consumption price average value of the hotel in the last month, the second group of data is a historical consumption price average value of the hotel in last two months, and so on, and the 24^{th} group of data is a historical consumption price average value of the hotel in last 24 months. When a historical consumption price average value of the hotel in a certain month does not exist, the historical consumption price average value of the hotel in the certain month is complemented via historical consumption price average values of the hotel in adjacent months. For example, if the fifth group of data does not exist, the fifth group of data can be obtained by calculation according to an average value of the fourth group of data and the sixth group of data.

Step 102, a consumption capacity of the target user with respect to the target object is determined by utilizing a preset hybrid neural network prediction model on the basis of the one or more statistical characteristic data and the one or more temporal sequence characteristic data.

The one or more statistical characteristic data and the one or more temporal sequence characteristic data of the target user are input to the preset hybrid neural network prediction model, so that the consumption capacity of the target user with respect to the target object can be obtained. The consumption capacity may be understood as a predicted consumption price.

After the consumption capacity of the target user with respect to the target object is predicted, a coupon with respect to the target object and matched with the consumption capacity may further be sent to the target user.

Coupons with different amounts may be set for different consumption capacities, and after the consumption capacity of the target user with respect to the target object is determined, a coupon with respect to the target object and matched with the consumption capacity is searched and then sent to the target user.

For example, when the target object is the hotel, the amount of a coupon may be 5 yuan off for every 100 yuan when the consumption capacity is 100 yuan to 199 yuan, the amount of a coupon may be 10 yuan off for every 200 yuan when the consumption capacity is 200 yuan to 399 yuan, and the amount of a coupon may be 50 yuan off for every 400 yuan when the consumption capacity is 400 yuan to 799 yuan. Therefore, when the consumption capacity of the target user with respect to the hotel predicted by utilizing the hybrid neural network prediction model is 240 yuan, a coupon with the amount being 10 yuan off for every 200 yuan may be sent to the target user. Certainly, when the consumption capacity is 240 yuan, a coupon with the amount being 5 yuan off for every 100 yuan may also be sent to the target user, but the preferential margin of the coupon of 10 yuan off for every 200 yuan is higher, so the possibility of actual consumption of the target user is higher.

In the embodiment of the present disclosure, on the basis of the one or more statistical characteristic data and in combination with the one or more temporal sequence characteristic data, characteristic extraction on the historical data in a temporal dimension can be implemented, so that the consumption capacity predicted by utilizing the hybrid neural network prediction model is more accurate, and thus the matched coupon is more accurate.

In addition, after the consumption capacity of the target user with respect to the target object is predicted, an advertisement with respect to the target object and matched with the consumption capacity may further be delivered to the target user.

After the consumption capacity of the target user with respect to the target object is determined, the advertisement with respect to the target object and matched with the consumption capacity is delivered to the target user. The precision and effect of advertisement delivery can be further improved by matching with the consumption capacity of the target user.

Certainly, after the consumption capacity of the target user with respect to the target object is determined, besides sending of the coupon and delivery of advertisement data, the determined consumption capacity can be further applied to other scenes, which is not limited by the embodiment of the present disclosure.

According to the consumption capacity prediction method disclosed by the embodiment of the present disclosure, the statistical characteristic data and the temporal sequence characteristic data with respect to the target object are obtained from the historical data of the target user, and the consumption capacity of the target user with respect to the target object is determined by utilizing the preset hybrid neural network prediction model on the basis of the statistical characteristic data and the temporal sequence characteristic data. The problem that the accuracy is relatively low when the consumption capacities of the users are determined by utilizing prices of commodities purchased by the users last time, prices of commodities purchased at one time randomly, or an average value of prices of historically purchased commodities in the prior art is solved. On the basis of the statistical characteristic data and in combination with the temporal sequence characteristic data, the characteristic extraction on the historical data in the temporal dimension can be implemented, so that the consumption capacity predicted by utilizing the hybrid neural network prediction model is more accurate.

### Embodiment II

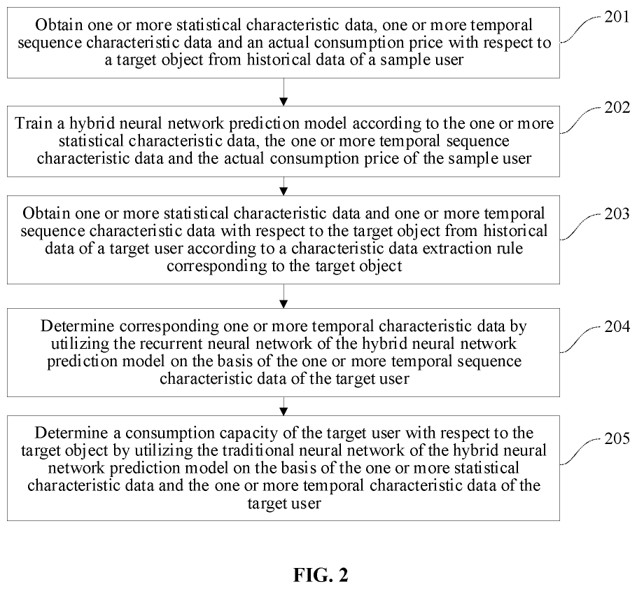

Referring to FIG. 2, a flow diagram of a consumption capacity prediction method according to Embodiment II of the present disclosure is illustrated. The method may specifically include the following steps.

Step 201, one or more statistical characteristic data, one or more temporal sequence characteristic data and an actual consumption price with respect to a target object are obtained from historical data of a sample user.

With respect to a certain target object, a user who has consumed the target object may be regarded as the sample user. The one or more statistical characteristic data, the one or more temporal sequence characteristic data and the actual consumption price of the sample user are obtained from the historical data of the sample user. The actual consumption price is an actual expenditure of the sample user for the target object at a designated date.

Step 202, a hybrid neural network prediction model is trained according to the one or more statistical characteristic data, the one or more temporal sequence characteristic data and the actual consumption price of the sample user. The hybrid neural network prediction model includes a recurrent neural network and a traditional neural network.

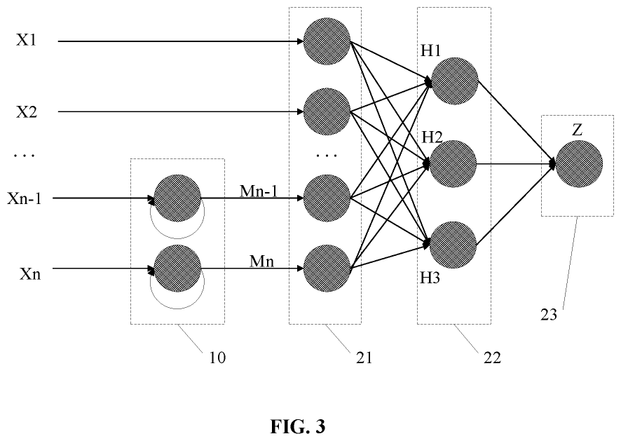

Referring to FIG. 3, a schematic diagram of the hybrid neural network prediction model of the present disclosure is illustrated.

In FIG. 3, X₁, X₂, . . . , Xₙ₋₁ and Xₙ represent input characteristic data of the sample user. n is a positive integer greater than or equal to 2. A part of the characteristic data is the one or more statistical characteristic data of the sample user, and is represented by specific numerical values. For example, X₁ may be a historical consumption price average value of the sample user with respect to the target object in the last week, and X₂ may be a historically browsed price average value of the sample user with respect to the target object in the last week. The characteristic data may further be a historical consumption price average value with respect to a non-target object in the last week, and a historically browsed price average value with respect to the non-target object in the last week. Besides the average values, statistical characteristic data such as a maximum value, a minimum value, a variance and a median may further be used. In addition, the characteristic data may further be statistical characteristic data such as a user level, a user active state and a permanent address of a user. The other part of the characteristic data is the one or more temporal sequence characteristic data of the sample user. For example, Xₙ₋₁=[s₁, s₂, . . . , s₂₄], wherein s₁ to s₂₄ are respectively historical consumption price average values with respect to the target object in every month of the last 24 months. Xₙ=[t₁, t₂, . . . , t₂₄], wherein t₁ to t₂₄ are respectively historical consumption price average values with respect to the non-target object in every month of the last 24 months.

It can be understood that two characteristic data may be input to the hybrid neural network prediction model, namely one statistical characteristic datum and one temporal sequence characteristic datum. However, when few characteristic data are input, parameters used in the hybrid neural network prediction model are few, and a deviation between a finally obtained consumption capacity and the actual consumption price will be large. When the characteristic data are input as much as possible, it may cause data redundancy and complex calculation, which has no improvement on a prediction result. In one implementation, 40 to 50 characteristic data may be selected, so the calculated amount of the model is relatively small, and a prediction result is relatively accurate.

The one or more statistical characteristic data, the one or more temporal sequence characteristic data and the actual consumption price of one sample user may constitute a set of training data, and a plurality of sets of training data are trained to obtain the hybrid neural network prediction model with respect to the target object.

The hybrid neural network prediction model may include the recurrent neural network and the traditional neural network. The temporal sequence characteristic data of the sample user are processed by utilizing the recurrent neural network, distribution characteristics of historical prices of the sample user in time are learned according to the temporal sequence characteristic data, and the temporal sequence characteristic data are calculated to obtain temporal characteristic data to be transmitted to the traditional neural network. The traditional neural network may be a fully-connected deep neural network (DNN), and the temporal characteristic data and the statistical characteristic data of the sample user are processed by the traditional neural network.

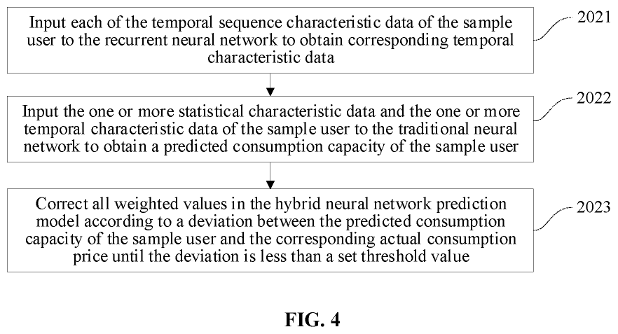

As shown in FIG. 4, an example flow diagram of step 202 according to the present embodiment is illustrated. Step 202 may include sub-step 2021, sub-step 2022 and sub-step 2023.

At sub-step 2021, each of the temporal sequence characteristic data of the sample user is input to the recurrent neural network to obtain the corresponding temporal characteristic data.

Each of the temporal sequence characteristic data of the sample user is to be processed by utilizing the recurrent neural network. Each of the temporal sequence characteristic data of the sample user is input to the recurrent neural network to obtain the temporal characteristic data of the sample user.

When one of the temporal sequence characteristic data of the sample user includes L sub-characteristic data arranged temporally, with respect to the temporal sequence characteristic data of the sample user, the first sub-characteristic data are input to the recurrent neural network to obtain an output result of the first sub-characteristic data, and output results of the m^{th} sub-characteristic data and the (m−1)^{th} sub-characteristic data are combined and input to the recurrent neural network until all the L sub-characteristic data in the temporal sequence characteristic data of the sample user are input so as to obtain the corresponding temporal characteristic data, where m is a positive integer greater than 1 and less than or equal to L. If a plurality of temporal sequence characteristic data exist in the hybrid neural network prediction model, other temporal sequence characteristic data are processed according to the same method to obtain the corresponding temporal characteristic data.

As shown in FIG. 3, 10 is the recurrent neural network, Mₙ₋₁ is the temporal characteristic data corresponding to the temporal sequence characteristic data Xₙ₋₁, and Mₙ is the temporal characteristic data corresponding to the temporal sequence characteristic data Xₙ.

As for the temporal sequence characteristic data Xₙ₋₁=[s₁, s₂, . . . , s₂₄], the first sub-characteristic data s₁ are input to the recurrent neural network to obtain the output result y₁ of the first sub-characteristic data, and y₁=f(U₁s₁). f represents an activation function of the recurrent neural network, and U₁ is a weighted value of the first sub-characteristic data s₁. Then, the second sub-characteristic data s₂ and the output result y₁ of the first sub-characteristic data are combined and input to the recurrent neural network to obtain an output result y₂ of the second sub-characteristic data, and y₂=f(U₂s₂+W₂y₁). U₂ is a weighted value of the second sub-characteristic data s₂, and W₂ is a weighted value of the output result y₁ of the first sub-characteristic data, and so on. The 24^{th} sub-characteristic data s₂₄ and an output result y₂₃ of the 23^{rd} sub-characteristic data are combined and input to the recurrent neural network to obtain the corresponding temporal characteristic data Mₙ₋₁=f(U₂₄s₂₄+W₂₄y₂₃). U₂₄ is a weighted value of the 24^{th} sub-characteristic data s₂₄, and W₂₄ is a weighted value of the output result y₂₃. Accordingly, the temporal characteristic data of the sample user are associated with each of the sub-characteristic data in the temporal sequence characteristic data. It should be noted that specific implementations of the recurrent neural network are not limited in the present disclosure. For example, an improved recurrent neural network may further be utilized to obtain the temporal characteristic data of the sample user.

Sub-step 2022, the one or more statistical characteristic data and the one or more temporal characteristic data of the sample user are input to the traditional neural network to obtain a predicted consumption capacity of the sample user.

For one sample user, the statistical characteristic data and the temporal characteristic data obtained through the temporal sequence characteristic data are input to the traditional neural network to obtain the predicted consumption capacity of the sample user.

As shown in FIG. 3, in order to simply illustrate the traditional neural network, the statistical characteristic data of the sample user are X₁ and X₂, the temporal characteristic data of the sample user are Mₙ₋₁ and Mₙ, and the statistical characteristic data X₁ and X₂ of the sample user and the temporal characteristic data Mₙ₋₁ and Mₙ of the sample user are input to the traditional neural network. Generally, the traditional neural network may be divided into an input layer 21, hidden layers 22 and an output layer 23, and then values of the hidden layers H₁, H₂ and H₃ are respectively obtained via formulas (1) to (3):

H₁=g(a₁X₁+a₂X₂+a₃Mₙ₋₁+a₄Mₙ) (1),

H₂=g(b₁X₁+b₂X₂+b₃Mₙ₋₁+b₄Mₙ) (2), and

H₃=g(c₁X₁+c₂X₂+c₃Mₙ₋₁+c₄Mₙ) (3).

g represents an activation function of the traditional neural network. In the formula (1), a₁ represents a weighted value from the input layer to the hidden layer H₁ with respect to the characteristic data X₁, a₂ represents a weighted value from the input layer to the hidden layer H₁ with respect to the characteristic data X₂, a₃ represents a weighted value from the input layer to the hidden layer H₁ with respect to the characteristic data Mₙ₋₁, and a₄ represents a weighted value from the input layer to the hidden layer H₁ with respect to the characteristic data Mₙ. In the formula (2), b₁ represents a weighted value from the input layer to the hidden layer H₂ with respect to the characteristic data X₁, b₂ represents a weighted value from the input layer to the hidden layer H₂ with respect to the characteristic data X₂, b₃ represents a weighted value from the input layer to the hidden layer H₂ with respect to the characteristic data Mₙ₋₁, and b₄ represents a weighted value from the input layer to the hidden layer H₂ with respect to the characteristic data Mₙ. In the formula (3), c₁ represents a weighted value from the input layer to the hidden layer H₃ with respect to the characteristic data X₁, c₂ represents a weighted value from the input layer to the hidden layer H₃ with respect to the characteristic data X₂, c₃ represents a weighted value from the input layer to the hidden layer H₃ with respect to the characteristic data Mₙ₋₁, and c₄ represents a weighted value from the input layer to the hidden layer H₃ with respect to the characteristic data Mₙ.

A value of the output layer Z is obtained via a formula (4).

Z=g(d₁H₁+d₂H₂+d₃H₃) (4).

g represents the activation function of the traditional neural network, d₁ represents a weighted value from the hidden layer H₁ to the output layer Z, d₂ represents a weighted value from the hidden layer H₂ to the output layer Z, and d₃ represents a weighted value from the hidden layer H₃ to the output layer Z.

The output layer Z represents the predicted consumption capacity of the sample user. It should be noted that the number of the hidden layers 22 in FIG. 3 is at least one, and the specific number of the hidden layers, the activation function f of the recurrent neural network and the activation function g of the traditional neural network are all determined through the statistical characteristic data, the temporal sequence characteristic data and the actual consumption price with respect to the target object of the sample user.

Sub-step 2023, all the weighted values in the hybrid neural network prediction model are corrected according to a deviation between the predicted consumption capacity of the sample user and the corresponding actual consumption price until the deviation is less than a set threshold value.

When the consumption capacity of the sample user is predicted for the first time, all the weighted values in the recurrent neural network and the traditional neural network may be set as arbitrary values. Then, the predicted consumption capacity of the sample user and the actual consumption price of the sample user with respect to the target object undergo subtraction to obtain a difference value between the two. All the weighted values in the hybrid neural network prediction model are corrected according to the magnitude of the difference value, that is, all the weighted values in the recurrent neural network and the traditional neural network are corrected. After continuous correction, the predicted consumption capacity may be more accurate until the deviation between the predicted consumption capacity of the sample user and the actual consumption price is less than the set threshold value. After training is completed, all the weighted values of the hybrid neural network prediction model are determined. Furthermore, predicted consumption capacities of a plurality of users may be obtained through sub-steps 2021 and 2022. Then deviations between the predicted consumption capacities of the plurality of users and actual consumption prices thereof are determined, and all the weighted values in the hybrid neural network prediction model are corrected. The weighted values obtained thereby are more accurate.

It should be noted that the obtained hybrid neural network prediction model can only predict the consumption capacity with respect to a certain target object. As for another target object, the statistical characteristic data and the temporal sequence characteristic data may be different. For example, as for another target object, different statistical characteristic data may be used, or same temporal characteristic data are used, but set time periods in the temporal characteristic data are different.

For example, when the target object is a hotel, the statistical characteristic data may include: a historical consumption price average value of the hotel in the last week, historical consumption price average values of other target objects except the hotel in the last week, etc. When the target object is a KTV, the statistical characteristic data may include: a historical consumption price median of the KTV in the last week, historical consumption price medians of other target objects except the KTV in the last week, etc. Similarly, when the target object is the hotel, the temporal sequence characteristic data may include: a historical consumption price average value of the hotel in the last 24 months. When the target object is the KTV, the temporal sequence characteristic data may include: a historical consumption price average value of the KTV in the last 24 months.

In addition, since a price parameter of the non-target object will influence a price parameter of the target object to a certain extent, the price parameter of the non-target object may serve as a kind of characteristic data. A better prediction result may be obtained by comprehensively considering the price parameter of the target object and the price parameter of the non-target object to predict the consumption capacity with respect to the target object.

Step 203, one or more statistical characteristic data and one or more temporal sequence characteristic data with respect to the target object are obtained from historical data of a target user according to a characteristic data extraction rule corresponding to the target object.

With respect to the target user whose consumption capacity needs to be predicted, firstly, the characteristic data extraction rule of the target object is determined, that is, all characteristic data used in the hybrid neural network prediction model are determined. In the present example, the price parameter of the target object may serve as a kind of characteristic data, and the price parameter of the non-target object may serve as another kind of characteristic data. Then, the statistical characteristic data and the temporal sequence characteristic data of the two kinds of characteristic data with respect to the target object are obtained from the historical data of the target user.

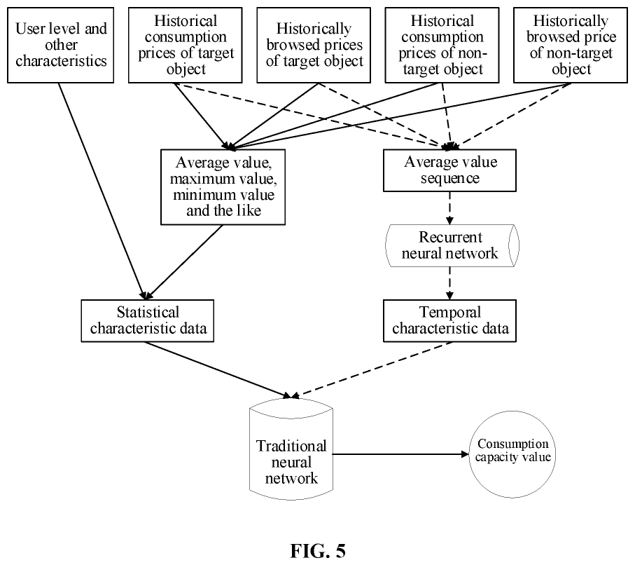

Referring to FIG. 5, a schematic flow diagram of consumption capacity prediction of the present disclosure is illustrated.

The statistical characteristic data may include: a historical consumption price parameter of the target object, a historically browsed price parameter of the target object, a historical consumption price parameter of the non-target object, a historically browsed price parameter of the non-target object, a user level and other characteristics.

The historical consumption price parameter of the target object may include an average value, a maximum value, a minimum value and the like of historical consumption prices of the target object. The historically browsed price parameter of the target object may include an average value, a maximum value, a minimum value and the like of historically browsed prices of the target object. The historical consumption price parameter of the non-target object may include an average value, a maximum value, a minimum value and the like of historical consumption prices of the non-target object. The historically browsed price parameter of the non-target object may include an average value, a maximum value, a minimum value and the like of historically browsed prices of the non-target object. The user level and other characteristics may include a user level, a user active state, a permanent address of a user and the like.

The temporal sequence characteristic data may include: an average value sequence of the historical consumption prices of the target object, an average value sequence of the historically browsed prices of the target object, an average value sequence of the historical consumption prices of the non-target object, an average value sequence of the historically browsed prices of the non-target object, and the like.

Step 204, corresponding one or more temporal characteristic data is determined by utilizing the recurrent neural network of the hybrid neural network prediction model on the basis of the one or more temporal sequence characteristic data of the target user.

As shown in FIG. 5, temporal sequence characteristic data of four target users are respectively input to the recurrent neural network, and four corresponding temporal characteristic data are determined by utilizing the recurrent neural network.

Step 205, the consumption capacity of the target user with respect to the target object is determined by utilizing the traditional neural network of the hybrid neural network prediction model on the basis of the one or more statistical characteristic data and the corresponding one or more temporal characteristic data of the target user.

As shown in FIG. 5, a plurality of statistical characteristic data and the four temporal characteristic data of the target user are input to the traditional neural network, and the consumption capacity of the target user with respect to the target object is determined by utilizing the traditional neural network.

Through a test, in one example, a consumption capacity of a user is determined according to an average value of prices of historically purchased commodities of the user, and an error thereof is 40 yuan. The error thereof is about 33 yuan when a general machine learning model is adopted, such as a linear regression (LR) model or a gradient boosting decision tree (GBDT). A final prediction error is about 30 yuan when the hybrid neural network prediction model of the present disclosure is adopted, and the consumption capacity predicted through the hybrid neural network prediction model is more accurate.

According to the consumption capacity prediction method disclosed by the embodiment in accordance with the present disclosure, the statistical characteristic data, the temporal sequence characteristic data and the actual consumption price with respect to the target object of the sample user are obtained from the historical data of the sample user, and training is performed according to the statistical characteristic data, the temporal sequence characteristic data and the actual consumption price with respect to the target object of the sample user so as to obtain the hybrid neural network prediction model. According to the characteristic data extraction rule corresponding to the target object, the statistical characteristic data and the temporal sequence characteristic data with respect to the target object are obtained from the historical data of the target user. The temporal characteristic data of the target user are determined by utilizing the recurrent neural network on the basis of the temporal sequence characteristic data of the target user. The consumption capacity of the target user with respect to the target object is determined by utilizing the traditional neural network on the basis of the statistical characteristic data and the temporal characteristic data of the target user. On the basis of the statistical characteristic data and in combination with the temporal sequence characteristic data, characteristic extraction on the historical data in a temporal dimension can be implemented through the recurrent neural network, so that the consumption capacity predicted by utilizing the hybrid neural network prediction model is more accurate.

For simple description, the method embodiments are expressed as a series of action combinations, but those skilled in the art should understand that the embodiments of the present disclosure are not limited by the described action sequences, because according to the embodiments of the present disclosure, certain steps may adopt other sequences or be carried out at the same time. Next, those skilled in the art also should understand that the embodiments described in the specification all belong to preferred embodiments, and related actions are not certainly necessary to the embodiments of the present disclosure.

### Embodiment III

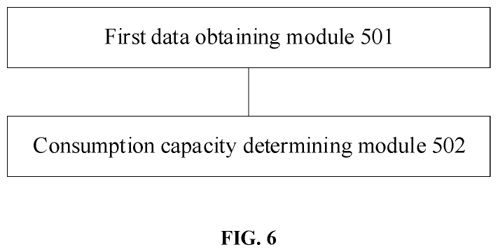

Referring to FIG. 6, a structure block diagram of a consumption capacity prediction apparatus according to Embodiment III of the present disclosure is illustrated.

The consumption capacity prediction apparatus of the embodiment of the present disclosure includes:

a first data obtaining module 501, configured to obtain one or more statistical characteristic data and one or more temporal sequence characteristic data with respect to a target object from historical data of a target user; and

a consumption capacity determining module 502, configured to determine a consumption capacity of the target user with respect to the target object by utilizing a preset hybrid neural network prediction model on the basis of the one or more statistical characteristic data and the one or more temporal sequence characteristic data.

According to the consumption capacity prediction apparatus provided by the embodiment in accordance with the present disclosure, the one or more statistical characteristic data and the one or more temporal sequence characteristic data with respect to the target object are obtained from the historical data of the target user, and the consumption capacity of the target user with respect to the target object is determined by utilizing the preset hybrid neural network prediction model on the basis of the one or more statistical characteristic data and the one or more temporal sequence characteristic data. The problem that the accuracy is relatively low when the consumption capacities of the users are determined by utilizing prices of commodities purchased by the users last time, prices of commodities purchased at one time randomly, or an average value of prices of historically purchased commodities in the prior art is solved. On the basis of the statistical characteristic data and in combination with the temporal sequence characteristic data, characteristic extraction on the historical data in a temporal dimension can be implemented, so that the consumption capacity predicted by utilizing the hybrid neural network prediction model is more accurate.

### Embodiment IV

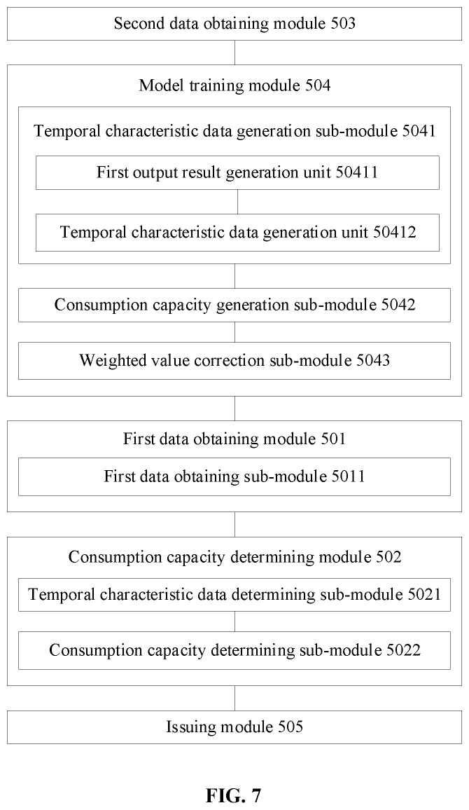

Referring to FIG. 7, a structure block diagram of a consumption capacity prediction apparatus according to Embodiment IV of the present disclosure is illustrated.

On the basis of Embodiment III, the consumption capacity prediction apparatus further includes:

a second data obtaining module 503, configured to obtain one or more statistical characteristic data, one or more temporal sequence characteristic data and an actual consumption price with respect to the target object from historical data of a sample user; and

a model training module 504, configured to train the hybrid neural network prediction model according to the one or more statistical characteristic data, the one or more temporal sequence characteristic data and the actual consumption price of the sample user, wherein the hybrid neural network prediction model includes a recurrent neural network and a traditional neural network.

The model training module 504, includes:

a temporal characteristic data generation sub-module 5041, configured to input each of the temporal sequence characteristic data of the sample user to the recurrent neural network to obtain corresponding temporal characteristic data;

a consumption capacity generation sub-module 5042, configured to input the one or more statistical characteristic data and the one or more temporal characteristic data of the sample user to the traditional neural network to obtain a predicted consumption capacity of the sample user; and

a weighted value correction sub-module 5043, configured to correct all weighted values in the hybrid neural network prediction model according to a deviation between the predicted consumption capacity of the sample user and the actual consumption price until the deviation is less than a set threshold value.

In some embodiments, when the temporal sequence characteristic data include L sub-characteristic data arranged temporally, the temporal characteristic data generation sub-module 5041 includes:

a first output result generation unit 50411, configured to input the first sub-characteristic data to the recurrent neural network to obtain an output result of the first sub-characteristic data; and

a temporal characteristic data generation unit 50412, configured to combine and input output results of the m^{th} sub-characteristic data and the (m−1)^{th} sub-characteristic data to the recurrent neural network until all the L sub-characteristic data are input so as to obtain the corresponding temporal characteristic data, wherein m is a positive integer greater than 1 and less than or equal to L.

On the basis of Embodiment III, the consumption capacity determining module 502 includes:

a temporal characteristic data determining sub-module 5021, configured to determine one or more temporal characteristic data of the target user by utilizing the recurrent neural network in the hybrid neural network prediction model on the basis of the one or more temporal sequence characteristic data of the target user; and

a consumption capacity determining sub-module 5022, configured to determine the consumption capacity of the target user with respect to the target object by utilizing the traditional neural network in the hybrid neural network prediction model on the basis of the one or more statistical characteristic data and the one or more temporal characteristic data of the target user.

On the basis of Embodiment III, the first data obtaining module 501 includes:

a first data obtaining sub-module 5011, configured to obtain the one or more statistical characteristic data and the one or more temporal sequence characteristic data with respect to the target object from the historical data of the target user according to a characteristic data extraction rule corresponding to the target object.

Further, the consumption capacity prediction apparatus also includes:

an issuing module 505, configured to send a coupon with respect to the target object and matched with the consumption capacity to the target user; and/or deliver an advertisement with respect to the target object and matched with the consumption capacity to the target user.

According to the consumption capacity prediction apparatus disclosed by the embodiment of the present disclosure, the statistical characteristic data, the temporal sequence characteristic data and the actual consumption price with respect to the target object of the sample user are obtained from the historical data of the sample user, and training is performed according to the statistical characteristic data, the temporal sequence characteristic data and the actual consumption price with respect to the target object of the sample user so as to obtain the hybrid neural network prediction model. According to the characteristic data extraction rule corresponding to the target object, the statistical characteristic data and the temporal sequence characteristic data with respect to the target object are obtained from the historical data of the target user. The temporal characteristic data of the target user are determined by utilizing the recurrent neural network on the basis of the temporal sequence characteristic data of the target user. The consumption capacity of the target user with respect to the target object is determined by utilizing the traditional neural network on the basis of the statistical characteristic data and the temporal characteristic data of the target user. On the basis of the statistical characteristic data and in combination with the temporal sequence characteristic data, characteristic extraction on the historical data in a temporal dimension can be implemented through the recurrent neural network, so that the consumption capacity predicted by utilizing the hybrid neural network prediction model is more accurate.

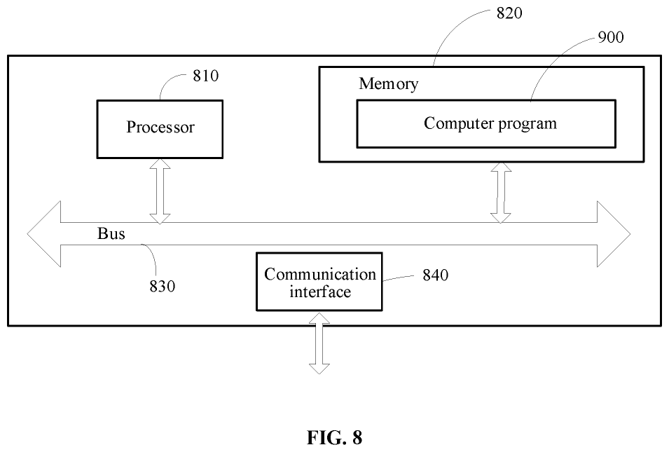

Accordingly, an electronic device is further disclosed, with reference to FIG. 8, the electronic device comprises a memory 820, a processor 810 and a computer program 900 stored on the memory 820 and capable of running on the processor, wherein the consumption capacity prediction method according to the embodiments I or II is implemented when the processor 810 executes the computer program. In alternative implements, the electronic device further comprises a bus 830 and a communication interface 840. The processor 810 and the memory 820 connect to each other via the bus 830, and may communicate with other devices or parts by the communication interface 840.

A readable storage medium having a computer program stored thereon is further disclosed, wherein the steps of the consumption capacity prediction method according to the embodiments I or II is implemented when the computer program is executed by the processor.

The apparatus embodiments are substantially similar to the method embodiments and therefore are only briefly described, and reference may be made to the method embodiments for the corresponding sections.

Algorithms and displaying provided herein are not inherently related to a particular computer, a virtual system, or another device. Various general purpose systems may also be used together with teachings herein. In accordance with the foregoing descriptions, a structure required for constructing such system is obvious. In addition, the present disclosure is not specific to any particular programming language. It should be understood that the content in the present disclosure described herein may be implemented by using various programming languages, and the foregoing description of the particular language is intended to disclose an optimal implementation of the present disclosure.

Lots of details are described in the specification provided herein. However, it will be appreciated that the embodiments of the present disclosure may be implemented in a case without these specific details. In some examples, known methods, structures, and technologies are not disclosed in detail, so as not to mix up understanding on the specification.

Similarly, it should be appreciated that to simplify the present disclosure and help to understand one or more of the inventive aspects, in the foregoing descriptions of the exemplary embodiments of the present disclosure, features of the present disclosure are sometimes grouped into a single embodiment or figure, or descriptions thereof. However, the methods in the present disclosure should not be construed as reflecting the following intention: that is, the present disclosure claimed to be protected is required to have more features than those clearly set forth in each claim. Or rather, as reflected in the following claims, the inventive aspects aim to be fewer than all features of a single embodiment disclosed above. Therefore, the claims complying with a specific implementation are definitely combined into the specific implementation, and each claim is used as a single embodiment of the present disclosure.

Those persons skilled in the art may understand that modules in the device in the embodiments may be adaptively changed and disposed in one or more devices different from that in the embodiments. Modules, units, or components in the embodiments may be combined into one module, unit, or component, and moreover, may be divided into a plurality of sub-modules, subunits, or subcomponents. Unless at least some of such features and/or processes or units are mutually exclusive, all features disclosed in this specification (including the accompanying claims, abstract, and drawings) and all processes or units in any disclosed method or device may be combined by using any combination. Unless otherwise definitely stated, each feature disclosed in this specification (including the accompanying claims, abstract, and drawings) may be replaced with a replacement feature providing a same, an equivalent, or a similar objective.

In addition, a person skilled in the art may understand that although some embodiments described herein include some features included in other embodiments instead of other features, a combination of features in different embodiments means that the combination falls within the scope of the present disclosure and forms a different embodiment. For example, in the following claims, any one of the embodiments claimed to be protected may be used by using any combination manner.

The component embodiments of the present disclosure may be implemented by using hardware, may be implemented by using software modules running on one or more processors, or may be implemented by using a combination thereof. A person skilled in the art should understand that some or all functions of some or all components according to the consumption capacity prediction apparatus of the embodiments of the present disclosure may be implemented by using a microprocessor or a digital signal processor (DSP) in practice. The present disclosure may further be implemented as a device or device program (for example, a computer program and a computer program product) configured to perform some or all of the methods described herein. Such program for implementing the present disclosure may be stored on a computer-readable medium, or may have one or more signal forms. Such signal may be obtained through downloading from an Internet website, may be provided from a carrier signal, or may be provided in any other forms.

It should be noted that the foregoing embodiments are descriptions of the present disclosure instead of a limitation on the present disclosure, and a person skilled in the art may design a replacement embodiment without departing from the scope of the accompanying claims. In the claims, any reference symbol located between brackets should not constitute a limitation on the claims. The word “comprise” does not exclude an element or a step not listed in the claims. The word “a” or “one” located previous to an element does not exclude existence of a plurality of such elements. The present disclosure may be implemented by hardware including several different elements and an appropriately programmed computer. In the unit claims listing several devices, some of the devices may be specifically presented by using the same hardware. Use of the words such as “first”, “second”, and “third” does not indicate any sequence. These words may be construed as names.

1. A computer implemented method for predicting consumption capacity, comprising:
obtaining one or more statistical characteristic data and one or more temporal sequence characteristic data with respect to a target object from historical data of a target user; and
determining a consumption capacity of the target user with respect to the target object by utilizing a preset hybrid neural network prediction model on the basis of the one or more statistical characteristic data and the one or more temporal sequence characteristic data.

2. The method according to claim 1, further comprising:
obtaining one or more statistical characteristic data, one or more temporal sequence characteristic data and an actual consumption price with respect to the target object from historical data of a sample user; and
training the hybrid neural network prediction model according to the one or more statistical characteristic data, the one or more temporal sequence characteristic data and the actual consumption price of the sample user, wherein the hybrid neural network prediction model comprises a recurrent neural network and a traditional neural network.

3. The method according to claim 2, wherein training the hybrid neural network prediction model according to the one or more statistical characteristic data, the one or more temporal sequence characteristic data and the actual consumption price of the sample user comprises:
inputting each of the temporal sequence characteristic data of the sample user to the recurrent neural network to obtain corresponding temporal characteristic data;
inputting the one or more statistical characteristic data and the one or more temporal characteristic data of the sample user to the traditional neural network to obtain a predicted consumption capacity of the sample user; and
correcting all weighted values in the hybrid neural network prediction model according to a deviation between the predicted consumption capacity of the sample user and the actual consumption price until the deviation is less than a set threshold value.

4. The method according to claim 3, wherein when the temporal sequence characteristic data comprise L sub-characteristic data arranged temporally, obtaining the corresponding temporal characteristic data comprises:
inputting the first sub-characteristic data to the recurrent neural network to obtain an output result of the first sub-characteristic data; and
combining and inputting output results of the m^{th} sub-characteristic data and the (m−1)^{th} sub-characteristic data to the recurrent neural network until all the L sub-characteristic data are input so as to obtain the corresponding temporal characteristic data, wherein m is a positive integer greater than 1 and less than or equal to L.

5. The method according to claim 1, wherein determining the consumption capacity of the target user with respect to the target object by utilizing the hybrid neural network prediction model on the basis of the one or more statistical characteristic data and the one or more temporal sequence characteristic data comprises:
determining one or more temporal characteristic data of the target user by utilizing a recurrent neural network in the hybrid neural network prediction model on the basis of the one or more temporal sequence characteristic data of the target user; and
determining the consumption capacity of the target user with respect to the target object by utilizing a traditional neural network in the hybrid neural network prediction model on the basis of the one or more statistical characteristic data and the one or more temporal characteristic data of the target user.

6. The method according to claim 1, wherein obtaining the one or more statistical characteristic data and the one or more temporal sequence characteristic data with respect to the target object from the historical data of the target user comprises:
obtaining the one or more statistical characteristic data and the one or more temporal sequence characteristic data with respect to the target object from the historical data of the target user according to a characteristic data extraction rule corresponding to the target object.

7. The method according to claim 1, further comprising:
sending a coupon with respect to the target object and matched with the consumption capacity to the target user; and/or
delivering an advertisement with respect to the target object and matched with the consumption capacity to the target user.

8. (canceled)

9. An electronic device, comprising a memory, a processor and a computer program stored on the memory and capable of running on the processor, wherein when executing the computer program, the processor is caused to perform actions comprising:
obtaining one or more statistical characteristic data and one or more temporal sequence characteristic data with respect to a target object from historical data of a target user; and
determining a consumption capacity of the target user with respect to the target object by utilizing a preset hybrid neural network prediction model on the basis of the one or more statistical characteristic data and the one or more temporal sequence characteristic data.

10. A non-transitory computer readable storage medium, wherein a computer program is stored on the readable storage medium, and when the computer program is executed by a processor, the processor is caused to perform actions comprising:
obtaining one or more statistical characteristic data and one or more temporal sequence characteristic data with respect to a target object from historical data of a target user; and
determining a consumption capacity of the target user with respect to the target object by utilizing a preset hybrid neural network prediction model on the basis of the one or more statistical characteristic data and the one or more temporal sequence characteristic data.

11. The electronic device according to claim 9, wherein the actions further comprise:
obtaining one or more statistical characteristic data, one or more temporal sequence characteristic data and an actual consumption price with respect to the target object from historical data of a sample user; and
training the hybrid neural network prediction model according to the one or more statistical characteristic data, the one or more temporal sequence characteristic data and the actual consumption price of the sample user, wherein the hybrid neural network prediction model comprises a recurrent neural network and a traditional neural network.

12. The electronic device according to claim 11, wherein training the hybrid neural network prediction model according to the one or more statistical characteristic data, the one or more temporal sequence characteristic data and the actual consumption price of the sample user comprises:
inputting each of the temporal sequence characteristic data of the sample user to the recurrent neural network to obtain corresponding temporal characteristic data;
inputting the one or more statistical characteristic data and the one or more temporal characteristic data of the sample user to the traditional neural network to obtain a predicted consumption capacity of the sample user; and
correcting all weighted values in the hybrid neural network prediction model according to a deviation between the predicted consumption capacity of the sample user and the actual consumption price until the deviation is less than a set threshold value.

13. The electronic device according to claim 12, wherein when the temporal sequence characteristic data comprise L sub-characteristic data arranged temporally, obtaining the corresponding temporal characteristic data comprises:
inputting the first sub-characteristic data to the recurrent neural network to obtain an output result of the first sub-characteristic data; and
combining and inputting output results of the m^{th} sub-characteristic data and the (m−1)^{th} sub-characteristic data to the recurrent neural network until all the L sub-characteristic data are input so as to obtain the corresponding temporal characteristic data, wherein m is a positive integer greater than 1 and less than or equal to L.

14. The electronic device according to claim 9, wherein determining the consumption capacity of the target user with respect to the target object by utilizing the hybrid neural network prediction model on the basis of the one or more statistical characteristic data and the one or more temporal sequence characteristic data comprises:
determining one or more temporal characteristic data of the target user by utilizing a recurrent neural network in the hybrid neural network prediction model on the basis of the one or more temporal sequence characteristic data of the target user; and
determining the consumption capacity of the target user with respect to the target object by utilizing a traditional neural network in the hybrid neural network prediction model on the basis of the one or more statistical characteristic data and the one or more temporal characteristic data of the target user.

15. The electronic device according to claim 9, wherein obtaining the one or more statistical characteristic data and the one or more temporal sequence characteristic data with respect to the target object from the historical data of the target user comprises:
obtaining the one or more statistical characteristic data and the one or more temporal sequence characteristic data with respect to the target object from the historical data of the target user according to a characteristic data extraction rule corresponding to the target object.

16. The electronic device according to claim 9, wherein the actions further comprise:
sending a coupon with respect to the target object and matched with the consumption capacity to the target user; and/or
delivering an advertisement with respect to the target object and matched with the consumption capacity to the target user.

17. The non-transitory computer readable storage medium according to claim 10, wherein the actions further comprise:
obtaining one or more statistical characteristic data, one or more temporal sequence characteristic data and an actual consumption price with respect to the target object from historical data of a sample user; and
training the hybrid neural network prediction model according to the one or more statistical characteristic data, the one or more temporal sequence characteristic data and the actual consumption price of the sample user, wherein the hybrid neural network prediction model comprises a recurrent neural network and a traditional neural network.

18. The non-transitory computer readable storage medium according to claim 17, wherein training the hybrid neural network prediction model according to the one or more statistical characteristic data, the one or more temporal sequence characteristic data and the actual consumption price of the sample user comprises:
inputting each of the temporal sequence characteristic data of the sample user to the recurrent neural network to obtain corresponding temporal characteristic data;
inputting the one or more statistical characteristic data and the one or more temporal characteristic data of the sample user to the traditional neural network to obtain a predicted consumption capacity of the sample user; and
correcting all weighted values in the hybrid neural network prediction model according to a deviation between the predicted consumption capacity of the sample user and the actual consumption price until the deviation is less than a set threshold value.

19. The non-transitory computer readable storage medium according to claim 10, wherein determining the consumption capacity of the target user with respect to the target object by utilizing the hybrid neural network prediction model on the basis of the one or more statistical characteristic data and the one or more temporal sequence characteristic data comprises:
determining one or more temporal characteristic data of the target user by utilizing a recurrent neural network in the hybrid neural network prediction model on the basis of the one or more temporal sequence characteristic data of the target user; and
determining the consumption capacity of the target user with respect to the target object by utilizing a traditional neural network in the hybrid neural network prediction model on the basis of the one or more statistical characteristic data and the one or more temporal characteristic data of the target user.

20. The non-transitory computer readable storage medium according to claim 10, wherein obtaining the one or more statistical characteristic data and the one or more temporal sequence characteristic data with respect to the target object from the historical data of the target user comprises:
obtaining the one or more statistical characteristic data and the one or more temporal sequence characteristic data with respect to the target object from the historical data of the target user according to a characteristic data extraction rule corresponding to the target object.

21. The non-transitory computer readable storage medium according to claim 10, wherein the actions further comprise:
sending a coupon with respect to the target object and matched with the consumption capacity to the target user; and/or
delivering an advertisement with respect to the target object and matched with the consumption capacity to the target user.
